(19) United States
(12) Patent Application Publication
(10) Pub. No.: US 2011/0253232 A1
(43) Pub. Date: Oct. 20, 2011

(54) Pressure Sensitive Oxygenation Valve Construction, Intermediate Assembly and Method of Using the Same

(75) Inventors: David W. SELINE, Strongsville, OH (US); William G. HARTMAN, North Royalton, OH (US); Linda BROCKMAN, Strongsville, OH (US); Mary Beth RUSIN, Olmstead Falls, OH (US); Bassam HALLAK, Newport (AU); David R. GARDNER, Strongsville, OH (US); Nicholas GRECO, Berea, OH (US)

(73) Assignee: AVERY DENNISON CORPORATION, Pasadena, CA (US)

(21) Appl. No.: 13/041,801

(22) Filed: Mar. 7, 2011

Related U.S. Application Data
(60) Provisional application No. 61/310,739, filed on Mar. 5, 2010.

(51) Int. Cl. F16K 37/00; B32B 38/10; B32B 37/14; B32B 38/14; B32B 37/02; B32B 37/12

(52) U.S. Cl. 137/551; 156/247; 137/561 R

(57) ABSTRACT

A multi-layer valve is provided for allowing oxygen to enter a package while maintaining a level of fluid and leak resistance. The multi-layer valve includes a first layer of adhesive that has a top and bottom face with the bottom face being adhered to a release liner. A permeable layer is provided over the first layer of adhesive, a second layer of adhesive that has a top and bottom face. The bottom face of the first adhesive layer is adhered to the permeable layer and the top face of the first adhesive layer is adhered to a cover layer such that the bottom face of the second layer of adhesive is separable from the permeable layer while the top face of the second layer of adhesive maintains adhesion with the cover layer.

### CROSS-REFERENCE TO RELATED APPLICATION

The present application claims the benefit of U.S. Provisional Patent Application No. 61/310,739 filed Mar. 5, 2011, which is incorporated herein by reference in its entirety.

### FIELD OF THE INVENTION

The present invention relates to valves and intermediate assemblies used as valves. More specifically the present invention relates to a pressure sensitive, multi layer oxygenation pressure sensitive construction that allows oxygen to enter the interior of a package while still maintaining fluid leak resistance.

### BACKGROUND OF THE INVENTION

Various types of packaging options are available today and are often used by consumers, industries, and numerous retailers to store food and other consumables for later use or consumption. It is also important for food retailers to present a product that appears desirable to consumers resulting in the increase of product sales. For example, grocery stores have a desire to make certain products such as types of meat, e.g. beef, pork, lamb, chicken, ham, etc.—look attractive and appealing to consumers.

Case ready meats, namely those that are packaged by the food producer or wholesale supplier and not by the retailer, typically utilize low oxygen modified atmosphere packaging to help prevent microbial growth and provide extended shelf life for the product. However, the absence of oxygen can cause the meat to take on a purple color due to the presence of myoglobin molecules. When a selection of case ready meat is subsequently exposed to oxygen, the myoglobin turns to oxymyoglobin which causes the meat will “bloom” and turn a bright red color.

The bright red color is perceived to be much more visually appealing to the consumer. Ideally this “re-oxygenation process” occurs as close to the retail sale as possible to maximize the shelf life of the case ready packaged product through the use of modified atmosphere packaging (“MAP”). Retailers/wholesalers “bloom” the meat as close to retail as possible in order to maximize the oxymyoglobin color. That is, by removing oxygen from the pack i.e. low oxygen MAP one receives the benefit of a longer shelf life. Hence, the retailer can use low oxygen MAP (30% CO2: 70% N2) case ready to increase shelf life i.e. from about 7 days for high oxygen (i.e. 30% CO2: 70% O2) to about 14-21 days.

Therefore a need exists in the marketplace for a valve construction that enables the retailer to activate the package to allow oxygen to enter the package in order to enhance the appearance of the product but which still maintains a hermetic seal against other contaminants that are generally undesirable and maintains MAP in the package. In addition, there is a need for a structure that is compatible with current packaging needs so as to be readily adaptable to conventional container construction and processing techniques (e.g. filling).

### BRIEF SUMMARY OF THE INVENTION

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

The present invention provides a pressure sensitive modified atmosphere packaging (“MAP”) assembly for use in a packaging environment desirable for most food retailers. The construction of the present invention is an easy to use configuration that allows retailers to prepare the packaged food product prior to display, by creating a vent or valve to allow oxygen to be introduced into the interior of the container. It is also worth noting that suitability of the environment provided by the present invention is not limited to food articles but may be utilized for certain chemicals and/or plants which may have a beneficial need for exposure to oxygen.

The pressure sensitive assembly of the present invention provides a system that is able to provide oxygen removal while maintaining the integrity of the package, namely retaining the leak resistance of the package. In addition, the structure of the present invention is readily adaptable to current packaging requirements thereby readily facilitating the assembly in the food processing and packaging flow.

In accordance with one exemplary embodiment of the presently described invention, a multi-layer valve assembly, is described and includes a carrier that has a top surface and a bottom surface. A first layer of adhesive has a top and a bottom face with the bottom face adhered to the carrier and the first layer of adhesive having a perimeter. A permeable layer is provided over the top face of the first layer of adhesive and the permeable layer has a perimeter or an outer diameter. A second layer of adhesive has a top and a bottom face with the bottom face being adhered to the permeable layer and the top face adhered to a cover layer. The second layer of adhesive has a perimeter that is larger than the perimeter of the first layer of adhesive such that a portion of the second layer of adhesive is connected to the carrier. The cover layer is in substantial juxtaposition with the second layer of adhesive to form a removable layer and the bottom face of the second layer of adhesive is separable from the permeable layer to move from a closed position to an open position while the top face of the second layer of adhesive remains adhered to the cover layer so that the removable portion can be readily peeled away from the permeable layer. In an alternate embodiment, the removable layer can be resealed over the permeable layer.

In a further exemplary embodiment of the present invention a multi-layer intermediate valve or vent assembly for use with a case ready package is described and includes a release liner, and a layer of permanent adhesive having a top and bottom face, the bottom face is temporarily and removably adhered to the release liner. The layer of permanent adhesive has an exterior diameter. An air permeable layer of material is provided over the top face of the permanent adhesive layer and the air permeable layer has a diameter. A layer of removable adhesive has a top and a bottom face. The bottom face is adhered to the air permeable layer on a side opposite that of the layer of permanent adhesive, and the top face is adhered to a removable cover layer. The layer of removable adhesive extends beyond the exterior diameter of at least one of the layer of permanent adhesive or the permeable layer. The top face of the removable adhesive layer remains adhered to the cover layer and the bottom face of the removable adhesive layer is separable from the air permeable layer to create a removable seal that operates between an open and close position.

In a still further exemplary embodiment, a method of making a multi layer valve assembly is presented and includes the steps of initially providing a package that has an opening in a surface of a package such as a package wall or lidding film associated with the package. Next, a valve assembly is provided that has a removable seal over an air permeable material. The valve assembly is adhered over the opening in the surface so that the permeable material is also over the opening in the surface. The removable seal is lifted to expose the permeable material and the opening in the surface of the package to an external atmosphere. The removable seal can be closed to conceal the microperforated, non-woven or other suitable material as well as to close the opening in the surface of the package.

In a yet still further exemplary embodiment provided in accordance with the present invention, a package assembly is presented and includes a package that has a surface that may be a package wall or lidding film with an opening therein. The package further includes a pressure sensitive valve assembly that is secured over the opening to form a pressure sensitive valve assembly. The assembly includes a first adhesive layer that is applied around the opening in the surface of the package. The first adhesive layer has an opening that is substantially in alignment with the opening in the surface. A permeable layer is applied over the first adhesive layer opposite the opening in the surface of the package. The permeable layer covers the opening in the first adhesive layer and the opening in the surface. A removable adhesive layer is applied on top of the woven layer and a cover layer is applied over the removable adhesive layer. The cover layer and the removable adhesive layer form a removable seal. The removable seal is operable from a closed position to an open position.

Other features and advantages of the present invention will become apparent to those skilled in the art from the following detailed description. It is to be understood, however, that the detailed description of the various embodiments and specific examples, while indicating preferred and other embodiments of the present invention, are given by way of illustration and not limitation. Many changes and modifications within the scope of the present invention may be made without departing from the spirit thereof, and the invention includes all such modifications.

### BRIEF DESCRIPTION OF THE DRAWINGS

These, as well as other objects and advantages of this invention, will be more completely understood and appreciated by referring to the following more detailed description of the presently preferred exemplary embodiments of the invention in conjunction with the accompanying drawings, of which:

FIG. 1 depicts a sectional view of the multi-layer valve;

FIG. 2 is a block diagram of an exemplary method for adhering an oxygenation valve to a package and allowing oxygen to enter the package;

FIG. 3 illustrates a partial top view of a multi-layer valve assembly provided in accordance with the present invention;

FIG. 3A provides a partial elevation of the valve assembly of FIG. 3;

FIG. 4 shows a side elevation of the multilayer valve assembly of the present invention attached to a package;

FIG. 5 presents a side view of the valve assembly of the presently described invention showing the removable seal of the valve in an open position;

FIG. 6 presents a side view of the valve assembly of an additional embodiment of the presently described invention showing an adhesive layer with an outer perimeter defined by the overall valve perimeter;

FIG. 6A shows a top view of an intermediate construction of the valve assembly of FIG. 6; and

FIG. 6B shows a top view of the valve assembly of FIG. 6.

### DETAILED DESCRIPTION OF THE INVENTION

The present invention is now illustrated in greater detail by way of the following detailed description which represents the best presently known mode of carrying out the invention. However, it should be understood that this description is not to be used to limit the present invention, but rather, is provided for the purpose of illustrating the general features of the invention.

The present invention relates to a pressure sensitive, multilayer valve assembly that may be manufactured economically and efficiently and can be readily adapted for inclusion in conventional package applications, particularly modified atmosphere packaging (“MAP”). The valve assembly is generally permanently attached to a package but provides a removable configuration which can be utilized to allow air or oxygen into the package. The removable portion can either be removed completely from the assembly or alternatively, the removable portion may then be reapplied to prevent further contamination of the contents.

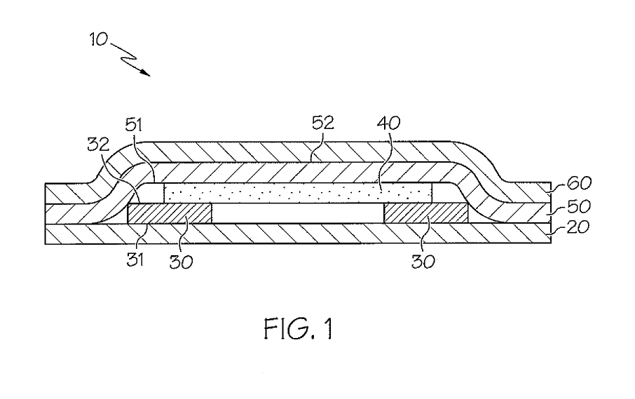

Reference is directed now to FIG. 1, in which a multi-layer valve or venting assembly 10 is provided. The valve or venting assembly allows specific environmental elements, i.e. oxygen, which is available externally of the package to enter the interior of the package while maintaining a level of fluid and leak resistance, that is preventing the contents of the package from leaking to the external environment through the valve assembly.

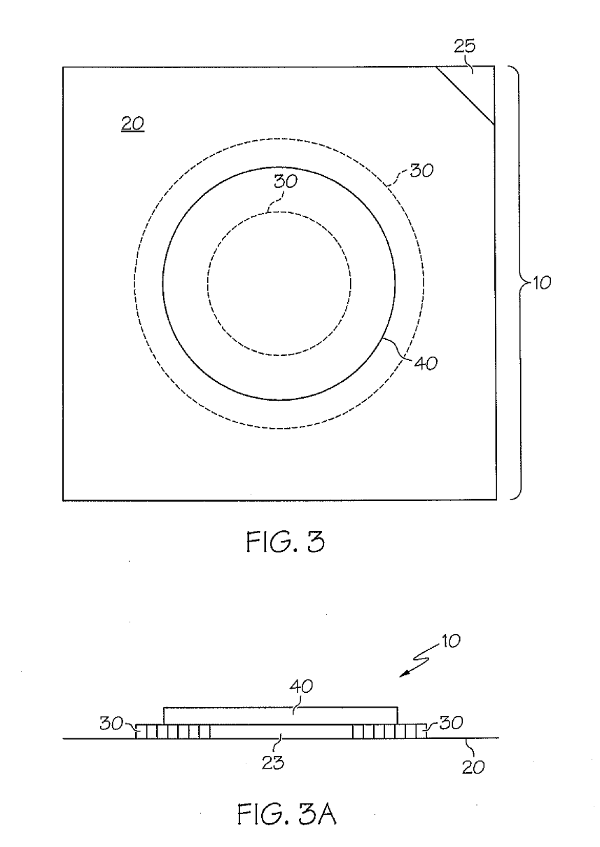

More specifically, a multi-layer valve assembly 10 is disclosed that includes a first layer of adhesive 30 with a perimeter. The perimeter has an internal and external diameter (as shown in FIG. 3) with the interior diameter defining an opening. The first layer of adhesive 30 has a top face 32 and a bottom face 31. The first layer of adhesive has an opening 23 (see FIG. 3A) defined by the interior perimeter, that is aligned with an opening 23 (see FIG. 3A) in a package to allow for the flow of air or other component from the exterior of the package into the interior of the packaging. Preferably the layer of adhesive 30 is a permanent pressure sensitive adhesive such as a hot melt acrylic, but generally should be an adhesive that is “generally recognized as safe” (“GRAS”) for use with indirect food contact packaging.

In one embodiment, where an intermediate construction is contemplated, such as when a series of valves or vents are provided for inclusion in the packaging line, the bottom face 31 of the adhesive layer can be temporarily and removably adhered to a release liner 20 or carrier web. The release liner 20 may be a conventional silicone coated substrate, a highly calendared material or other suitable components that may provide a sufficient release function to enable the valve assembly 10 to be easily removed from the release liner 20. In this manner, the pressure sensitive valve assemblies can be manufactured in large numbers, collected on a spool or roll and then unwound at the packaging location and combined with the film material which is likely also delivered in a roll format.

Still referring to FIG. 1 permeable layer 40 that is moisture resistant is provided over the top face 32 of the first layer of adhesive 30. In one embodiment, the permeable layer 40 has an outer perimeter that is less than the outer perimeter of the first layer of adhesive 30, alternatively, the outer perimeter of the permeable layer 40 may be equal to that of the outer perimeter of the adhesive layer 30 or overlap that of the adhesive layer 30, that is the outer perimeter of the permeable layer 40 may also extend beyond the outer perimeter of the adhesive layer 30.

A second layer of adhesive 50 has an outer perimeter with top 52 and bottom 51 faces that is provided over the permeable layer 40. The bottom face 51 of the second layer of adhesive 50 is at least partially adhered to the permeable layer 40. In a preferred embodiment, the second layer of adhesive 50 has an outer perimeter that is larger than the outer perimeter of the first layer of adhesive 30 resulting in the bottom face 51 of the second layer of adhesive 50 fully covering the permeable layer 40 and adhering to the remainder or exposed area of the top face of the first layer of adhesive 30 that is not adhered to the permeable layer 40 in a situation where the first adhesive layer 30 has a perimeter that extends beyond the permeable layer 40. Alternatively, the second layer of adhesive 50, may avoid contact with the first layer 30 of adhesive.

A portion of the bottom face 51 of the second layer of adhesive 50 extends beyond the permeable layer 40 and the top face 32 of the first layer of adhesive 30 and may be directly connected to a release liner 20 in combination with the first layer of adhesive 30 and subsequently will be attached to the package when the valve assembly 10 is connected to a surface of a package or film to be made into a package once the assembly is removed from the release liner.

The top face 52 of the second layer of adhesive 50 is adhered to a cover layer 60. A portion of the bottom face 51 of the second layer of adhesive 50 that is adhered to the permeable layer 40 is separable from the permeable layer 40 while a portion of the bottom face 51 of the second layer of adhesive 50 may be adhered to the top face 32 of the first layer of adhesive 30 that extends beyond the perimeter of the permeable layer 40. The top face 52 of the second layer of adhesive 50 maintains a removable adhesive contact with the cover layer 60. Where the perimeter of the first layer 30 of adhesive is equal to or less than the perimeter or diameter of the permeable layer 40, the two adhesive layers 30, 50 will not be in direct contact with one another.

Attachment of the bottom face 31 of the first layer of adhesive 30 to a release liner 20, allows the adhesive properties of the first layer of adhesive 30 to be maintained until the multi-layer valve or vent 10 is attached to a surface of a package 80. Attachment of the top face 32 of the first layer of adhesive 30 to the permeable layer 40 allows the moisture resistant permeable layer 40 to remain permanently attached to the surface of the packaging 80 via the permanent adhesive. As used herein, the term surface of the packaging may include a wall that is part of the film or packaging material or a lidding film that is applied to a portion of the wall of the packaging material.

The permeable layer 40 can be a spun bonded fabric, or non-woven material, which is preferred. The non-woven material is broadly defined as a porous sheet or web structure bonded together by entangling fibers or filament of the material. Nonwoven material provides specific functionality such as absorbency, liquid repellency, resilience, stretch, softness, and sterility. Preferably non-woven material can be constructed out of a form of polyester such as polyethylene terephthalate (PET), cotton, or other synthetic or natural fibers. Alternatively, the permeable layer 40 can be a perforated film. Because the permeable layer 40 is intended to be moisture resistant but not impervious to gas the permeable layer 40 permits air or other desired elements to enter the package's interior while generally keeping the interior of the package dry. This construction enables a producer or retailer to deliberately fill the package chamber with oxygen and reseal the package contents to prevent any further contamination.

Alternatively, as mentioned above the permeable layer 40 can be an aperture or perforated film. An aperture film is film having a plurality of openings such as holes, gaps, or slits throughout. The openings can be circular however various geometric shapes are contemplated in the present invention. The openings can be created by mechanical cutting, perfing, laser cutting or by other suitable means. The openings can be sized to allow certain components to enter and exit the packaging based upon the diameter of the openings. Only those components with a size sufficient to fit through the opening of the aperture film are able to go back and forth between the interior and exterior of the receptacle. These microperforations range from about 0.05 mm to about 5 mm depending on the requirements of the packaging.

The second layer of adhesive 50 in an exemplary embodiment is a removable pressure sensitive adhesive forming only a temporary bond with the permeable layer 40 allowing for separation between the second adhesive layer 50 and the permeable layer 40. The second layer of adhesive 50 is capable of being re-adhered, when desired, to the permeable layer 40, and package forming a seal between the package and the outside environment.

In an exemplary embodiment of the present invention, the multi-layer valve 10 is re-usable, meaning that the second layer of adhesive 50 can be removed from the permeable layer 40 and package a multitude of times thereby allowing the re-activating and de-activating the seal to open and close the package wall.

A cover layer 60 is adhered to the top face 52 of the second adhesive layer 50 in order to provide protection to the permeable layer 40 when the valve or venting assembly 10 is in a sealed condition. The cover layer 60 in combination with the second adhesive layer 50 forms a removable label like structure which when removed allows for air or other desirable elements to flow through the permeable layer 40 into the interior of the package. Graphics and/or other indicia can be printed on the cover layer 60 such as a company logo or useful information about the valve assembly attached to the product such as use, removal and resealing instructions.

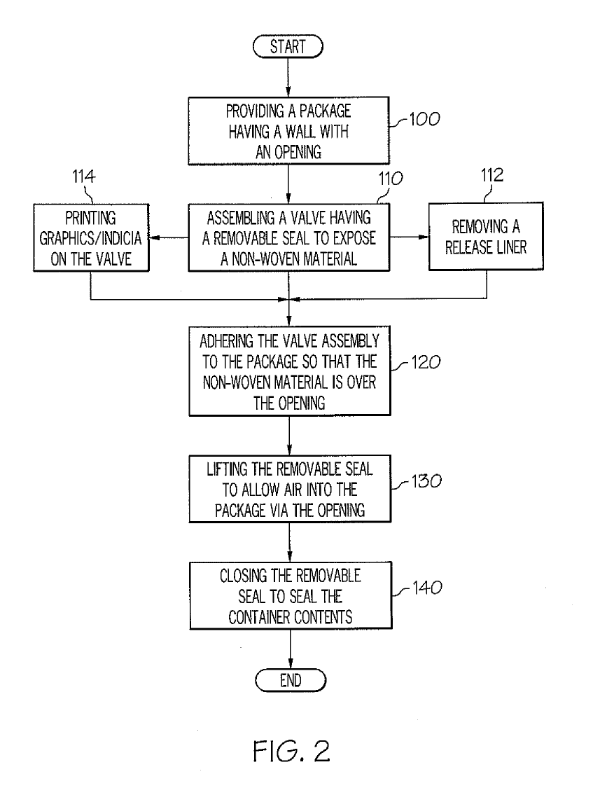

Reference is now directed to FIG. 2 which provides a block diagram of an exemplary method for applying a pressure sensitive, multilayer oxygenation valve or vent to a package to allow oxygen into a package. Initially, at step 100 a package is provided that has a surface which may include a package wall or lidding film and an opening in the surface. Next, at step 110 a pressure sensitive, multilayer valve assembly is created with a removable seal which will expose a permeable material when the seal is lifted. The valve assembly of step 110 may be provided on a release liner and at step 112 prior to step 120 in which the valve assembly is provided on the package surface so that the permeable material is over the opening in the package, the valve assembly is removed from the release liner. In an alternate step, printing of graphics and indicia may be provided at step 114, and is preferably done before the valve assembly is provided to the package. However, the graphics and indicia may also be provided after the valve assembly has been attached to the package at step 120.

As previously indicated, the valve assembly is attached to the package at step 120. This may be accomplished such as through providing a source of valve or venting assemblies on a continuous web and then feeding the web to an insertion placement or dispensing device, which removes each assembly from the web and places the individual valve assembly on a package, film for a package or container. A permanent adhesive secures the valve assembly to the container.

Next, at step 130, a retailer, consumer, processor or other user can peel up the removable sealing layer to allow treatment of the interior of the package, such as by allowing air or filling the package space with oxygen. A removable adhesive allows the cover layer to be peeled back while remaining adhered to the top face 52 of the second layer of adhesive 50, where the second layer extends beyond the permeable layer 40 exposing the permeable layer to allow oxygen egress. In constructions where the first layer of adhesive does not extend beyond the permeable layer, the removable adhesive layer 50 may remain partially attached to the packaging surface. Alternatively, the removable adhesive and cover layer may be stripped off the package surface completely.

The removable sealing layer can be replaced at step 140 if desired so as to eliminate any further passages of air or oxygen and to prevent any fluid leakage or exposure to moisture or the like.

Attention is now directed to FIG. 3 which provides a top view of a portion of the pressure sensitive, multilayer valve assembly 10. The valve assembly as shown is approximately 1″ by 1″ and of course may be manufactured in a wide variety of dimensions as may be required for a particular application. As previously indicated, the valve assembly 10 is temporarily provided on a release liner 20 which serves as a carrier during the manufacture and assembly of the valve as well as potentially to provide a carrier for the application to the package during assembly and loading of the package. The release liner 20 is provided with a peel tab area 25 in which an area of the first adhesive layer 30 has been deadened so that the valve assembly 10 may be easily lifted from the carrier 20. The size of the peel tab is such to allow adequate lifting of the tab, but does not degrade the adhering force of the adhesive. Alternatively, the adhesive layer 30 could be patterned coated so that there is no adhesive in the area of the removable tab.

Still referring to FIG. 3, the first adhesive layer 30, having a generally circular dimension, has a diameter shown by the arrows in the figure. The outside diameter is approximately (three quarters of an inch) ¾″ and the inner diameter is approximately (three eighths of an inch) ⅜″. The outer diameter of the permeable layer 40 is shown as being disposed internally of the outer diameter of the first adhesive layer 30. The diameter of the permeable is approximately (one half inch) ½″. While the dimension as shown is generally round or circular, it should be understood that any geometric or other perform shape may be provided. It should be understood, that the diameter of the first layer of adhesive may be coterminous with the permeable layer or the permeable layer may extend beyond the perimeter of the permeable layer.

FIG. 3A shows a partial side elevation of the valve assembly 10 as provided in FIG. 3. The first adhesive layer 30 is disposed on the release layer 20 in an annular or circular arrangement. The first adhesive layer 30 has an opening 23 which will be provided over an opening in the container or package surface as will be subsequently described.

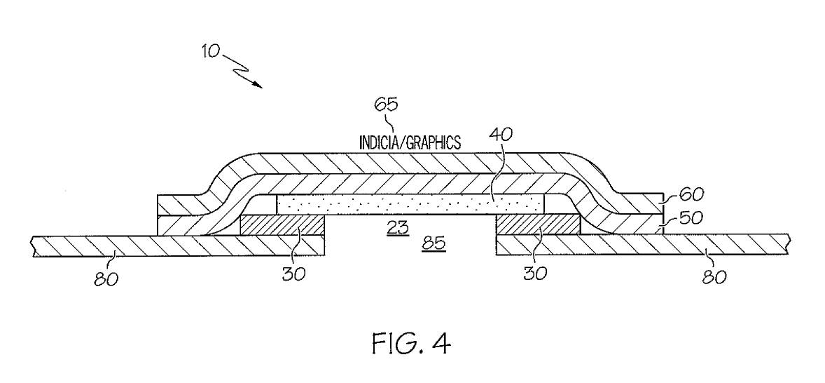

FIG. 4 shows a side elevation of the valve assembly 10 of the presently described invention attached to a package surface which may include either directly attaching the assembly 10 to the wall 80 of the packaging or lidding film that may be applied over the wall 80 of a container or package. The valve assembly 10 is shown in the sealed or closed position. The package surface 80 has an opening 85. The first layer of adhesive 30 is applied so as to position the valve assembly 10 in operative association with the opening 85. That is, the opening of the valve assembly and that of the package wall are in substantial alignment with one another. Alternatively, the opening in the package can be larger than the opening of the valve assembly, so long as the opening of the package assembly is not larger than the perimeter of the first adhesive layer 30 of the valve assembly.

The first adhesive layer 30 has an opening 23 which is shown as being roughly in alignment with the opening 85 in the surface 80. While the opening 23 of the first adhesive layer 30 is shown in substantial juxtaposition with the opening 85 of the container wall 80, it should be understood that the openings may be slightly splayed out of alignment with one another. The second adhesive layer 50 and the cover layer 60 extend beyond each end of the permeable layer 40 and the first adhesive layer 30 to form a seal around the periphery of the opening 23 and 85.

FIG. 4 also shows that indicia and/or graphics 65 have been applied to the top of the cover layer 60. The printing may occur when the valve assembly is completed or alternatively, prior to the cover layer 60 being added to the valve assembly 10. The printing may be applied over the adhesive layer 50, in which case the cover layer would need to be transparent or translucent to allow the printing to be visible.

Layer 50 in an alternative configuration may be a frangible layer such that when the removable cover layer is peeled back from the permeable layer 40, the bond securing the cover layer 60 to the permeable layer will break and the cover layer 60 cannot be reapplied over the top of the permeable layer. As used herein, adhesive layer can include an adhesive bonding layer or a frangible layer depending on the requirements of the application for which it is used.

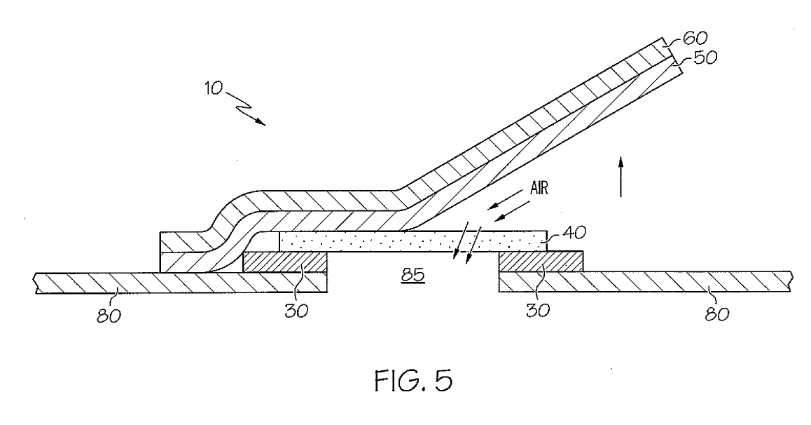

The cover layer 60 and the second adhesive layer 50 combine to form the removable sealing portion as provided in FIG. 5 which shows the valve assembly 10 in the open or unsealed position. As can be seen in FIG. 5, the first layer of adhesive 30 remains affixed to the surface 80 of the container so that the permeable layer 40 remains in position on the first adhesive layer 30. This allows air or oxygen to be introduced into the opening 85 of the surface 80 of the container through the permeable material 40.

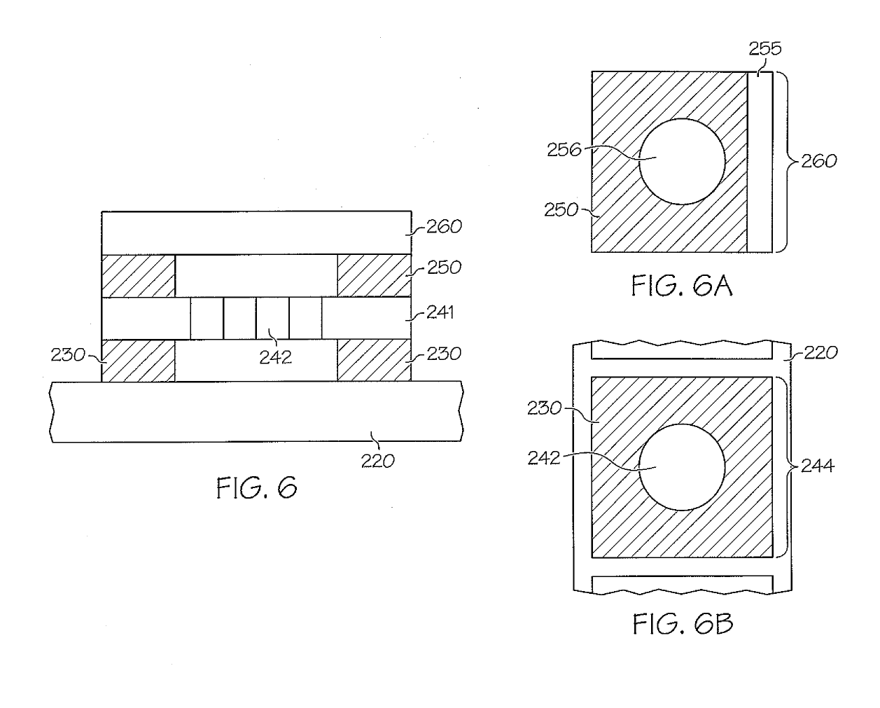

FIG. 6, a multi-layer valve assembly is disclosed that includes a first layer of adhesive 230 with outer perimeter defined by the overall valve perimeter. The perimeter has an internal diameter (as shown in FIG. 6B) with the interior diameter defining an opening. The first layer of adhesive 230 has a top face 232 and a bottom face 231. The first layer of adhesive has an opening 242 (see FIG. 6B) defined by an inner perimeter, that is aligned with an opening (see FIG. 6B) in a package to allow for the flow of air or other component from the exterior of the package into the interior of the packaging. Preferably the layer of adhesive 230 is a permanent pressure sensitive adhesive such as a hot melt acrylic, but generally should be an adhesive that is “generally recognized as safe” (“GRAS”) for use with indirect food contact packaging.

In one embodiment, where an intermediate construction is contemplated, such as when a series of valves or vents are provided for inclusion in the packaging line, the bottom face 231 of the adhesive layer can be temporarily and removably adhered to a release liner 220 or carrier web. The release liner 220 may be a conventional silicone coated substrate, a highly calendared material or other suitable components that may provide a sufficient release function to enable the valve assembly 210 to be easily removed from the release liner 220. In this manner, the pressure sensitive valve assemblies can be manufactured in large numbers, collected on a spool or roll and then unwound at the packaging location and combined with the film material which is likely also delivered in a roll format.

Still referring to FIG. 6 a permeable layer 241 is created that is moisture resistant is provided over the top face 232 of the first layer of adhesive 230. The first layer of adhesive 230 is preferably a permanent adhesive that is pattern coated. In one embodiment, the permeable layer 240 has an outer perimeter that equal to the perimeter of the first layer of adhesive 230. This is accomplished by using a non-permeable film and creating openings by having a plurality of openings such as holes, gaps, or slits, that may be formed by laser cutting, mechanical die cutting or slitting or other similar operation, throughout in the area 242 (FIG. 6B). The opening may range from about 10 microns to 200 microns with about 100 microns to about 175 microns being preferred and about 150 microns being more preferred. Graphics and/or other indicia can be printed on the permeable layer 241 such as a company logo or useful information about the valve assembly attached to the product such as use, removal and resealing instructions.

A second layer of adhesive 250 has an outer perimeter defined by the overall valve perimeter with top 252 and bottom 251 faces that is provided over the permeable layer 241. The inner perimeter is equal to or greater the size of 242 (FIG. 6B) represented by 256 (FIG. 6A). The bottom face 251 of the second layer of adhesive 250 is at least partially adhered to the permeable layer 241 as shown in 256 (FIG. 6A). Area 256 (FIG. 6A) can be created by not having adhesive or by printing a non-tacky layer in the pattern of 256. Also area 255 (FIG. 6A) is created to aid in the removing of layer 260, this area can be created by not having adhesive, deadened adhesive or by printing a non-tacky layer in the pattern of 255.

The top face 252 of the second layer of adhesive 250 is adhered to a cover layer 260 (FIG. 6). The bottom face 251 of the second layer of adhesive 250 maintains a removable adhesive contact with the permeable layer 241. The bond between the bottom face 251 and the permeable layer 241 can be modified by using a patterned release coating on top of the permeable layer 241 that resembles the pattern of the second layer of adhesive 250 (FIG. 6A).

Attachment of the bottom face 231 of the first layer of adhesive 230 to a release liner 220, allows the adhesive properties of the first layer of adhesive 230 to be maintained until the multi-layer valve or vent 210 is attached to a surface of a package 280. Attachment of the top face 232 of the first layer of adhesive 230 to the permeable layer 241 allows the moisture resistant permeable layer 241 to remain permanently attached to the surface of the packaging 280 via the permanent adhesive. As used herein, the term surface of the packaging may include a wall that is part of the film or packaging material or a lidding film that is applied to a portion of the wall of the packaging material.

The permeable layer 241 can be a perforated film made from polyester such as polyethylene terephthalate (PET), polypropylene, polyethylene, BOPP, a mixture of the before mention materials, or something similar. Because the permeable layer 241 is intended to be moisture resistant but not impervious to gas the permeable layer 241 permits air or other desired elements to enter the package's interior while generally keeping the interior of the package dry. This construction enables a producer or retailer to deliberately fill the package chamber with oxygen and reseal the package contents to prevent any further contamination. The openings can be circular however various geometric shapes are contemplated in the present invention. The openings can be sized to allow certain components to enter and exit the packaging based upon the diameter of the openings. Only those components with a size sufficient to fit through the opening of the aperture film are able to go back and forth between the interior and exterior of the receptacle. These microperforations range from about 0.05 mm to about 5 mm depending on the requirements of the packaging.

The second layer of adhesive 250 in an exemplary embodiment is a pattern coated, removable pressure sensitive adhesive forming only a temporary bond with the permeable layer 241 allowing for separation between the second adhesive layer 250 and the permeable layer 241. The second layer of adhesive 250 is capable of being re-adhered, when desired, to the permeable layer 240, and package forming a seal between the package and the outside environment.

In an exemplary embodiment of the present invention, the multi-layer valve 210 is re-usable, meaning that the second layer of adhesive 250 can be removed from the permeable layer 240 and package a multitude of times thereby allowing the re-activating and de-activating the seal to open and close the package wall.

A cover layer 260 is adhered to the top face 252 of the second adhesive layer 250 in order to provide protection to the permeable layer 240 when the valve or venting assembly 210 is in a sealed condition. The cover layer 260 is selected to have sufficient barrier properties to prevent the exchange of gas with the interior of the package, until the cover layer is removed.

The cover layer 260 in combination with the second adhesive layer 250 forms a removable label like structure which when removed allows for air or other desirable elements to flow through the permeable layer 241 into the interior of the package. Graphics and/or other indicia can be printed on the cover layer 260 such as a company logo or useful information about the valve assembly attached to the product such as use, removal and resealing instructions. The cover layer 260 may also be provided with a tab portion that can be an uncoated area of adhesive, area of deadened adhesive, overprinted area or the like. Cover layer 260 is preferably a PvDC coated PET, or provided with some other coating or properties to create a barrier to gas and/or fluid.

In an exemplary embodiment of the invention, the permeable layer is permeable to air thus facilitating air flow into a package or other receptacle. The permeable layer may also exhibit permeability to gas. The invention provides that even though the permeable layer allows outside elements usually air into the interior of the package, the permeable layer is resistant to moisture.

It will thus be seen according to the present invention a highly advantageous multi-layer valve has been provided. While the invention has been described in connection with what is presently considered to be the most practical and preferred embodiment, it will be apparent to those of ordinary skill in the art that the invention is not to be limited to the disclosed embodiment, and that many modifications and equivalent arrangements may be made thereof within the scope of the invention, which scope is to be accorded the broadest interpretation of the appended claims so as to encompass all equivalent structures and products.

The inventors hereby state their intent to rely on the Doctrine of Equivalents to determine and assess the reasonably fair scope of their invention as it pertains to any apparatus, system, method or article not materially departing from but outside the literal scope of the invention as set out in the following claims.

What is claimed is:

1. A multi-layer valve assembly, comprising:
a carrier, having a top surface and a bottom surface;
a first layer of adhesive with an opening having a top and bottom face with the bottom face adhered to the carrier, the first layer of adhesive having a perimeter;
a permeable layer provided over the top face of the first layer of adhesive, the permeable layer having a perimeter or diameter;
a second layer of adhesive having a top and bottom face with the bottom face adhered to the permeable layer and the top face adhered to a cover layer, the second layer of adhesive having a perimeter that is larger than the perimeter of the first layer of adhesive such that at least a portion of the second layer of adhesive is in contact with the carrier;
the cover layer is in substantial juxtaposition with the second layer of adhesive forming a removable layer; and
the bottom face of the second layer of adhesive is separable from the permeable layer to move from a closed position to an open position while the top face of the second layer of adhesive remains adhered to the cover layer.

2. The multi-layer valve of claim 1, wherein the permeable layer is permeable to air.

3. The multi-layer valve of claim 1, wherein graphics or indicia are provided on the cover layer.

4. The multi-layer valve of claim 1, wherein the multi-layer valve is fluid resistant.

5. The multi-layer valve of claim 1, wherein the permeable layer is gas permeable.

6. The multi-layer valve of claim 1, wherein the permeable layer is moisture resistant.

7. The multi-layer valve of claim 1, wherein the first layer of adhesive is a permanent pressure sensitive adhesive.

8. The multi-layer valve of claim 1, wherein the second layer of adhesive is a removable pressure sensitive adhesive.

9. The multi-layer valve of claim 1, wherein the permeable layer is a non-woven material.

10. The multi-layer valve of claim 1, wherein the permeable layer is an aperture film

11. The multi-layer valve of claim 1, wherein the multi-layer valve is adhered to a package.

12. A multi-layer valve intermediate assembly for use with a package, comprising;
a release liner;
a layer of permanent adhesive having a top and bottom face, the bottom face temporarily adhered to the release liner, the layer of permanent adhesive having an exterior diameter;
an air permeable layer of material provided over the top face of the permanent adhesive layer, the air permeable layer having a diameter;
a layer of removable adhesive having a top and bottom face with the bottom face adhered to the air permeable layer on a side opposite that of the layer of permanent adhesive, and the top face is adhered to a removable cover layer, the layer of removable adhesive extending beyond the diameter of one of the layer of permanent adhesive or air permeable layer; and
wherein the top face of the removable adhesive layer remains adhered to the cover layer and the bottom face of the removable adhesive layer is separable from the air permeable layer to create a removable seal that operates between an open and close position.

13. A method of making a multi layer valve assembly, comprising the steps of:
providing a package having an opening in a surface;
providing a valve assembly having a removable seal over a non-woven or microperforated material to form a permeable material;
adhering the valve assembly over the opening in the wall so that the permeable material is over the opening in the surface;
lifting the removable seal to expose the permeable material and opening in the surface of the package to an external atmosphere; and
closing the removable seal to conceal the permeable material and close the opening in the surface of the package.

14. The method of claim 13, wherein a permanent adhesive layer is provided to secure the valve assembly over the opening in the surface.

15. The method of claim 13, wherein a removable adhesive is used to create the removable seal.

16. The method of claim 13, including the additional step of removing a release liner from the valve assembly prior to the step of adhering the valve assembly.

17. The method of claim 13, including the additional step of printing indicia on the valve assembly after the step of assembling the valve assembly.

18. A package assembly, comprising;
a package having a surface with an opening therein; and
a pressure sensitive valve assembly secured over the opening, the pressure sensitive valve assembly including;
a first adhesive layer applied around the opening in the surface of the package, the first adhesive layer having an opening substantially in alignment with the opening in the surface;
a permeable layer applied over the first adhesive layer opposite the opening in the surface, the permeable layer covering the opening in the first adhesive layer and the opening in the surface;
a removable adhesive layer applied on top of the permeable layer; and
a cover layer applied over the removable adhesive layer, the cover layer and the removable adhesive layer forming a removable seal and the removable seal is operable from a closed position to an open position.

19. A package assembly as recited in claim 18, wherein the first adhesive layer has an interior and exterior diameter, with the interior diameter substantially equal to the opening in the surface.

20. A package assembly as recited in claim 19, wherein the removable layer and the cover layer each extend beyond the exterior diameter of the first adhesive layer.

21. A multi-layer valve assembly, comprising:
a carrier, having a top surface and a bottom surface;
a first layer of adhesive having a top and bottom face with the bottom face adhered to the carrier, the first layer of adhesive has an outer perimeter defined by the valve perimeter and an inner perimeter that is aligned with an opening in a package;
a permeable layer provided over the top face of the first layer of adhesive, the permeable layer having a perimeter or diameter and indicia can be printed on the permeable layer;
a second layer of adhesive having a top and bottom face with the bottom face adhered to the permeable layer and the top face adhered to a cover layer, the second layer of adhesive having a perimeter that is larger than the perimeter of the first layer of adhesive such that at least a portion of the second layer of adhesive is in contact with the carrier;
the cover layer is in substantial juxtaposition with the second layer of adhesive forming a removable layer; and
the bottom face of the second layer of adhesive is separable from the permeable layer to move from a closed position to an open position while the top face of the second layer of adhesive remains adhered to the cover layer.

22. The valve of claim 21, wherein a patterned release coating is used on top of the permeable layer.

23. A multi-layer valve assembly, comprising:
a carrier, having a top surface and a bottom surface;
a first layer of adhesive with an opening having a top and bottom face with the bottom face adhered to the carrier, the first layer of adhesive having a perimeter;
a non-permeable layer provided over the top face of the first layer of adhesive, the non-permeable layer having an outer perimeter equal to the perimeter of the first layer of adhesive, the non-permeable layer has a plurality of openings;
a second layer of adhesive having a top and bottom face with the bottom face adhered to the non-permeable layer and the top face adhered to a cover layer that is larger than the perimeter of the first layer of adhesive such that at least a portion of the second layer of adhesive is in contact with the carrier;
the cover layer is in substantial juxtaposition with the second layer of adhesive forming a removable layer; and
the bottom face of the second layer of adhesive is separable from the non-permeable layer to move from a closed position to an open position while the top face of the second layer of adhesive remains adhered to the cover layer.

24. A multi-layer valve assembly having a perimeter, comprising:
a carrier, having a top surface and a bottom surface;
a first layer of adhesive with an opening having a top and bottom face with the bottom face adhered to the carrier, the first layer of adhesive having a perimeter;
a permeable layer provided over the top face of the first layer of adhesive, the permeable layer having a valve perimeter or diameter;
a second layer of adhesive having a top and bottom face with the bottom face adhered to the permeable layer and the top face adhered to a cover layer, the second layer of adhesive having an outer and inner perimeter wherein the inner perimeter is defined by the valve perimeter;
the cover layer is in substantial juxtaposition with the second layer of adhesive forming a removable layer; and
the bottom face of the second layer of adhesive is separable from the permeable layer to move from a closed position to an open position while the top face of the second layer of adhesive remains adhered to the cover layer.

25. A multi-layer valve assembly as recited in claim 24, wherein the cover layer is a gas and fluid barrier.
